(19) United States
(12) Patent Application Publication
(10) Pub. No.: US 2023/0379811 A1
(43) Pub. Date: Nov. 23, 2023

(54) PLMN SELECTION IN INTERNATIONAL AREAS WHEN UE SUPPORTS NTN

(71) Applicant: MediaTek Singapore Pte. Ltd., Singapore (SG)

(72) Inventors: Marko NIEMI, Oulu (FI); Yuan-Chieh LIN, Hsinchu City (TW)

(73) Assignee: MediaTek Singapore Pte. Ltd., SINGAPORE (SG)

(21) Appl. No.: 18/247,322

(22) PCT Filed: Oct. 8, 2021
(86) PCT No.: PCT/CN2021/122561

§ 371 Date: Mar. 30, 2023

Related U.S. Application Data
(60) Provisional application No. 63/087,938, filed on Oct. 6, 2020.

(51) Int. Cl. H04W 48/18; H04W 8/24

(52) U.S. Cl. CPC H04W 48/18; H04W 8/24; H04W 84/06

(57) ABSTRACT

Solutions pertaining to public land mobile network (PLMN) selection in international areas when a user equipment (UE) supports non-terrestrial network (NTN) communications are proposed. An apparatus implemented in a UE transmits a message indicating that the UE has a capability of NTN communication over a satellite access. The apparatus also receives an indication indicating whether the UE is allowed to utilize one or more NTNs over the satellite access. The apparatus then performs a PLMN selection in a country area or in an international area based on the capability.

### CROSS REFERENCE TO RELATED PATENT APPLICATION

The present disclosure is part of a non-provisional application claiming the priority benefit of U.S. Provisional Patent Application No. 63/087,938, filed 6 Oct. 2020, the content of which being incorporated by reference in its entirety.

### TECHNICAL FIELD

The present disclosure is generally related to mobile communications and, more particularly, to public land mobile network (PLMN) selection in international areas when a user equipment (UE) supports non-terrestrial network (NTN) communications.

### BACKGROUND

Unless otherwise indicated herein, approaches described in this section are not prior art to the claims listed below and are not admitted as prior art by inclusion in this section.

In wireless communications such as mobile communications according to the 3rd Generation Partnership Project (3GPP) specifications, there is a Service Architecture 3-Legal Interception (SA3-LI) requirement that any solution addressing extraterritorial (e.g., international maritime zone and aeronautical) use cases should provide means to notify the home public land mobile network (HPLMN) on roaming in and out of those areas. Current PLMN selection procedure as defined in the 3GPP Technical Specification (TS) 23.122 does not define PLMN selection for NTN capable devices in international areas. On one hand, in current deployments, the coverage on ships and airplanes is typically provided by an on-board radio access network (RAN) which is, strictly speaking, in the territory of the country owning the vessel. On the other hand, SA3-LI requirement on PLMN selection in the same country does not necessarily apply to international areas. Therefore, there is a need for a solution regarding PLMN selection in international areas when a UE supports NTN communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, designs, concepts, techniques, methods, systems and apparatus to address aforementioned issues. Specifically, various proposed schemes in accordance with the present disclosure pertain to PLMN selection in international areas when a UE supports NTN communications.

In one aspect, a method may involve a UE transmitting a message indicating that the UE has a capability of NTN communication over a satellite access. The method may also involve the UE receiving an indication indicating whether the UE is allowed to utilize one or more NTNs over the satellite access. The method may further involve the UE performing a PLMN selection in a country area or in an international area based on the capability.

In another aspect, a method may involve a UE receiving a configuration from a network regarding a capability of the UE to support NTN communication over a satellite access. The method may also involve the UE performing a PLMN selection in a country area or in an international area based on the capability.

In yet another aspect, an apparatus implementable in a UE may include a configured to communicate wirelessly. The apparatus may also include a processor coupled to the transceiver. The processor may transmit, via the transceiver, a message indicating that the UE has a capability of NTN communication over a satellite access. The processor may receive, via the transceiver, an indication indicating whether the UE is allowed to utilize one or more NTNs over the satellite access. The processor may perform, via the transceiver, a PLMN selection in a country area or in an international area based on the capability.

It is noteworthy that, although description provided herein may be in the context of certain radio access technologies, networks and network topologies such as 5^{th} Generation (5G)/New Radio (NR) mobile networking and NTN communications, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT), Narrow Band Internet of Things (NB-IoT), Industrial Internet of Things (IIoT) and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PLMN selection in international areas when a UE supports NTN communications. According to the present disclosure, a number of possible solutions may be implemented separately or jointly. That is, although these possible solutions may be described below separately, two or more of these possible solutions may be implemented in one combination or another.

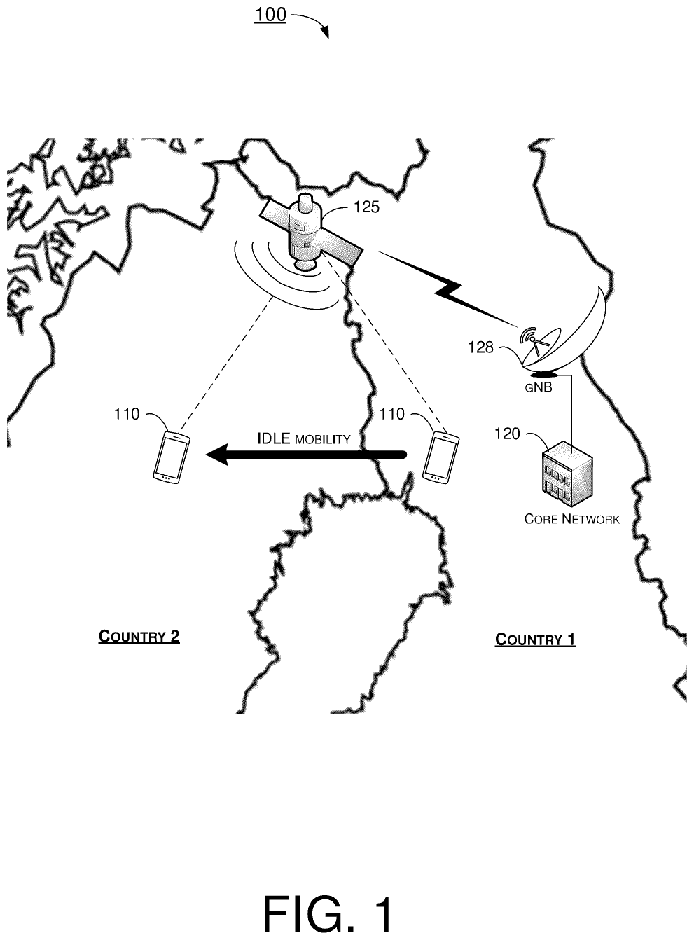

FIG. 1 illustrates an example network environment 100 in which various solutions and schemes in accordance with the present disclosure may be implemented. Referring to FIG. 1, network environment 100 may involve a UE 110 which may establish a wireless communication with a core network 120 via an non-terrestrial (NT) network node 125 (e.g., a satellite) as part of a communication network (e.g., part of an NTN). The NT network node 125 may be in communication with the core network 120 via a terrestrial network node 128 (e.g., a base station such as a gNB), and the NT network node 125 may be a low Earth orbiting (LEO) satellite, a medium Earth orbiting (MEO) satellite or a geosynchronous Earth orbiting (GEO) satellite. UE 110 may be initially in a first country (country 1) and later in a second country (country 2) as a result of, for example, UE 110 being physically onboard a vessel that travels from the first country to the second country. In network environment 100, UE 110 and network 120 may implement various schemes pertaining to PLMN selection in international areas when a UE supports NTN communications in accordance with the present disclosure, as described below.

Under a proposed scheme in accordance with the present disclosure with respect to UE configuration and/or UE capability, UE 110 may have a capability (or may be capable of being configured) to use or otherwise support NTN communications. For instance, UE 110 may have a capability or otherwise be configured to use or support NR NTN via spaceborne platforms such as LEO satellites, MEO satellites, and GEO satellites. Under the proposed scheme, UE 110 may indicate such a capability to network 120 during a registration procedure and, in response, network 120 may acknowledge with an indication to UE 110 as to whether or not UE 110 is accepted or allowed to use/support NTNs. Moreover, without any request from UE 110, network 120 may indicate to UE 110 in a registration accept message whether or not UE 110 is allowed to use NTNs.

Under the proposed scheme, the capability of UE 110 to support NTNs may be configured or pre-configured with a configuration stored in a memory or a Universal Subscriber Identity Module (USIM). For instance, a first configuration stored in a memory or USIM within or associated with UE 110 may inform UE 110 regarding whether or not UE 110 is capable of NTN communications over a satellite access. In addition, UE 110 may be separately and independently configured to support or not support selection of PLMNs broadcasting international mobile country codes (MCCs).

Under another proposed scheme in accordance with the present disclosure with respect to PLMN selection, in an event that UE 110 is allowed to use NTNs, UE 110 may perform PLMN selection different from another UE that is not capable or configured to use NTNs. Under the proposed scheme, depending on configurations, the NTN-capable UE 110 may select PLMNs from a same country (or a same MCC) as that associated with the current location of UE 110, or PLMNs broadcasting an international MCC, or both.

Under the proposed scheme, depending on configurations, for an NTN cell broadcasting international/global MCC (e.g., an MCC that starts with “9” as in “9xx”) UE 110 may treat such international MCC as being comparable (e.g., equal) to the MCC of a home country of UE 110 for PLMN selection. Moreover, UE 110 may consider or otherwise assign priorities to different PLMNs as follows: those PLMNs broadcasting the MCC of its home country may be assigned a first priority, those PLMNs broadcasting an international MCC may be assigned a second priority, and those PLMNs broadcasting MCCs of other countries may be assigned a third priority. The first priority may be higher than the second priority, and the second primary may be higher than the third priority. Accordingly, when not in the area of its home country, UE 110 may consider PLMNs broadcasting an international MCC as having a higher priority than those PLMNs broadcasting MCCs of other countries. For instance, a second configuration stored in a memory or USIM within or associated with UE 110 may inform UE 110 about priority order with respect to an international MCC and a country-specific MCC in a current UE location (e.g., first priority>second priority>third priority).

### Illustrative Implementations

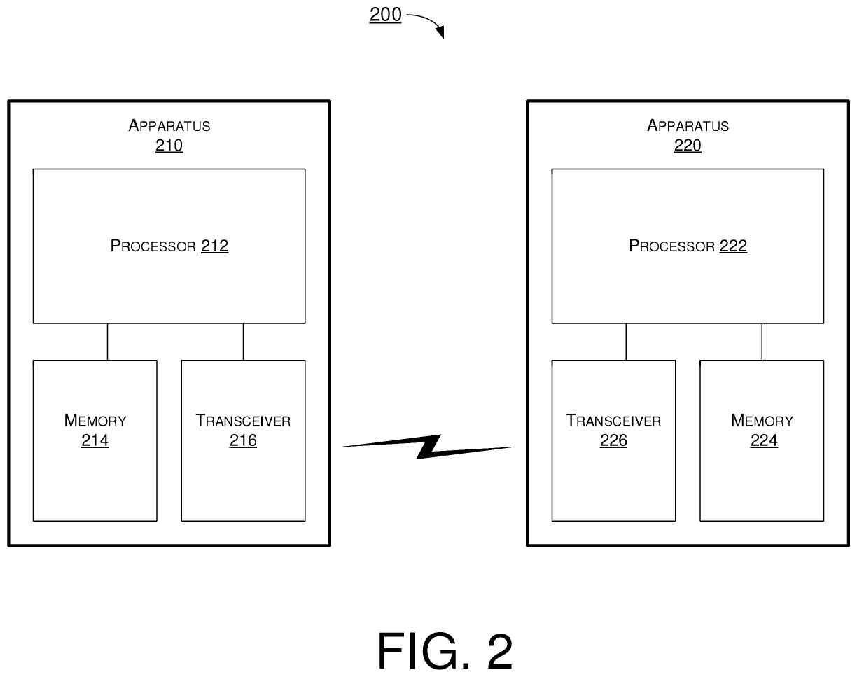

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to PLMN selection in international areas when a UE supports NTN communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to PLMN selection in international areas when a UE supports NTN communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., terrestrial network node 128 or NT network node 125) of a wireless network (e.g., network 120 as a 5G/NR mobile network), is provided below.

Under various proposed schemes in accordance with the present disclosure pertaining to PLMN selection in international areas when a UE supports NTN communications, processor 212 of apparatus 210, implemented in or as UE 110, may transmit, via transceiver 216, a message to a network (e.g., via apparatus 220 as terrestrial network node 128 or NT network node 125) indicating that the UE has a capability of NTN communication over a satellite access. Additionally, processor 212 may receive, via transceiver 216, an indication from the network indicating whether the UE is allowed to utilize one or more NTNs over the satellite access. Moreover, processor 212 may perform, via transceiver 216, a PLMN selection in a country area or in an international area based on the capability.

In some implementations, the capability may be set as a configuration stored in a memory or a USIM.

In some implementations, the indication may be received in a RRC or NAS message.

In some implementations, the capability message may be transmitted or the indication may be received during a registration procedure.

In some implementations, in performing the PLMN selection, processor 212 may perform certain operations. For instance, responsive to the indication indicating the UE is allowed to utilize the one or more NTNs over the satellite access, processor 212 may select a PLMN from one or more PLMNs broadcasting international MCCs and one or more PLMNs broadcasting a respective MCC that represents a current location of the UE. Additionally, responsive to the indication indicating the UE is not allowed to utilize the one or more NTNs, processor 212 may select another PLMN from one or more PLMNs available over a terrestrial network access.

In some implementations, in performing the PLMN selection, processor 212 may select a PLMN from one or more PLMNs broadcasting international MCCs and one or more PLMNs broadcasting a respective MCC consistent with a current location of the UE.

In some implementations, in performing the PLMN selection, processor 212 may perform certain operations. For instance, processor 212 may receive a first broadcast from a first PLMN indicating a first MCC that is associated with a home country of the UE. Additionally, processor 212 may assign the first PLMN a first priority. Also, processor 212 may receive a second broadcast from a second PLMN indicating a second MCC that is an international MCC. Moreover, processor 212 may assign the second PLMN a second priority lower than the first priority. Furthermore, p processor 212 may select the first PLMN responsive to the first priority being higher than the second priority.

In some implementations, in performing the PLMN selection, processor 212 may perform certain operations. For instance, processor 212 may receive a first broadcast from a first PLMN indicating a first MCC that is an international MCC. Additionally, processor 212 may assign the first PLMN a first priority. Moreover, processor 212 may receive a second broadcast from a second PLMN indicating a second MCC associated with a foreign country different from a home country of the UE. Furthermore, processor 212 may assign the second PLMN a second priority lower than the first priority. Also, processor 212 may select the first PLMN responsive to the first priority being higher than the second priority.

In some implementations, in performing the PLMN selection, processor 212 may perform certain operations. For instance, processor 212 may receive a first broadcast from a first PLMN indicating a first MCC that is associated with a home country of the UE. Additionally, processor 212 may assign the first PLMN a first priority. Also, processor 212 may receive a second broadcast from a second PLMN indicating a second MCC that is an international MCC. Moreover, processor 212 may assign the second PLMN a second priority lower than the first priority. Additionally, processor 212 may receive a third broadcast from a third PLMN indicating a third MCC associated with a foreign country different from the home country of the UE. Furthermore, processor 212 may assign the third PLMN a third priority lower than the second priority. Then, processor 212 may select the first PLMN responsive to the first priority being higher than the second priority and the third priority.

Under various proposed schemes in accordance with the present disclosure pertaining to PLMN selection in international areas when a UE supports NTN communications, processor 212 of apparatus 210, implemented in or as UE 110, may receive, via transceiver 216, a configuration from a network (e.g., via apparatus 220 as terrestrial network node 128 or NT network node 125) regarding a capability of the UE to support NTN communication over a satellite access. Furthermore, processor 212 may perform, via transceiver 216, a PLMN selection in a country area or in an international area based on the capability.

In some implementations, in receiving the configuration, processor 212 may receive the configuration in a RRC or NAS message.

In some implementations, processor 212 may perform additional operations. For instance, processor 212 may receive, via transceiver 216, from the network during a registration procedure an indication regarding whether or not the UE is allowed to utilize one or more NTNs over the satellite access.

In some implementations, in performing the PLMN selection, processor 212 may perform certain operations. For instance, responsive to the indication indicating the UE is allowed to utilize the one or more NTNs over the satellite access, processor 212 may select a PLMN from one or more PLMNs broadcasting international MCCs and one or more PLMNs broadcasting a respective MCC that represents a current location of the UE. Moreover, responsive to the indication indicating the UE is not allowed to utilize the one or more NTNs, processor 212 may select another PLMN from one or more PLMNs available over a terrestrial network access.

In some implementations, in performing the PLMN selection, processor 212 may select a PLMN one or more PLMNs broadcasting international MCCs and one or more PLMNs broadcasting a respective MCC consistent with a current location of the UE.

In some implementations, in performing the PLMN selection, processor 212 may perform certain operations. For instance, processor 212 may receive a first broadcast from a first PLMN indicating a first MCC that is associated with a home country of the UE. Additionally, processor 212 may assign the first PLMN a first priority. Moreover, processor 212 may receive a second broadcast from a second PLMN indicating a second MCC that is an international MCC. Furthermore, processor 212 may assign the second PLMN a second priority lower than the first priority. Also, processor 212 may select the first PLMN responsive to the first priority being higher than the second priority.

In some implementations, in performing the PLMN selection, processor 212 may perform certain operations. For instance, processor 212 may receive a first broadcast from a first PLMN indicating a first MCC that is an international MCC. Additionally, processor 212 may assign the first PLMN a first priority. Also, processor 212 may receive a second broadcast from a second PLMN indicating a second MCC associated with a foreign country different from a home country of the UE. Moreover, processor 212 may assign the second PLMN a second priority lower than the first priority. Furthermore, processor 212 may select the first PLMN responsive to the first priority being higher than the second priority.

In some implementations, in performing the PLMN selection, processor 212 may perform certain operations. For instance, processor 212 may receive a first broadcast from a first PLMN indicating a first MCC that is associated with a home country of the UE. Additionally, processor 212 may assign the first PLMN a first priority. Also, processor 212 may receive a second broadcast from a second PLMN indicating a second MCC that is an international MCC. Moreover, processor 212 may assign the second PLMN a second priority lower than the first priority. Additionally, processor 212 may receive a third broadcast from a third PLMN indicating a third MCC associated with a foreign country different from the home country of the UE. Moreover, processor 212 may assign the third PLMN a third priority lower than the second priority. Furthermore, processor 212 may select the first PLMN responsive to the first priority being higher than the second priority and the third priority.

### Illustrative Processes

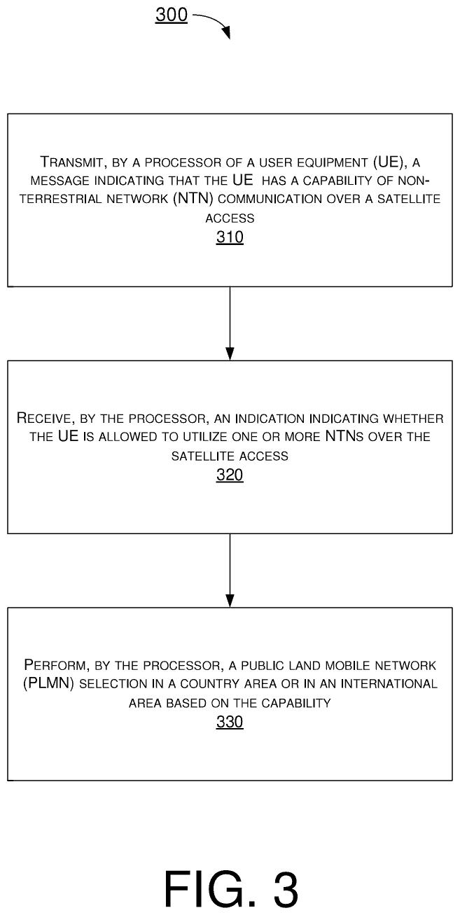

FIG. 3 illustrates an example process 300 in accordance with an implementation of the present disclosure. Process 300 may represent an aspect of implementing various proposed designs, concepts, schemes, systems and methods described above, whether partially or entirely, including those pertaining to those described above. More specifically, process 300 may represent an aspect of the proposed concepts and schemes pertaining to PLMN selection in international areas when a UE supports NTN communications. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., terrestrial network node 128 or NT network node 125) of a mobile communication network. Process 300 may begin at block 310.

At 310, process 300 may involve processor 212 of apparatus 210 transmitting, via transceiver 216, a message to a network (e.g., via apparatus 220) indicating that the UE has a capability of NTN communication over a satellite access. Process 300 may proceed from 310 to 320.

At 320, process 300 may involve processor 212 receiving, via transceiver 216, an indication from the network indicating whether the UE is allowed to utilize one or more NTNs over the satellite access. Process 300 may proceed from 320 to 330.

At 330, process 300 may involve processor 212 performing, via transceiver 216, a PLMN selection in a country area or in an international area based on the capability.

In some implementations, the capability may be set as a configuration stored in a memory or a USIM.

In some implementations, the indication may be received in a RRC or NAS message.

In some implementations, the capability message may be transmitted or the indication may be received during a registration procedure.

In some implementations, in performing the PLMN selection, process 300 may involve processor 212 performing certain operations. For instance, responsive to the indication indicating the UE is allowed to utilize the one or more NTNs over the satellite access, process 300 may involve processor 212 selecting a PLMN from one or more PLMNs broadcasting international MCCs and one or more PLMNs broadcasting a respective MCC that represents a current location of the UE. Additionally, responsive to the indication indicating the UE is not allowed to utilize the one or more NTNs, process 300 may involve processor 212 selecting another PLMN from one or more PLMNs available over a terrestrial network access.

In some implementations, in performing the PLMN selection, process 300 may involve processor 212 selecting a PLMN from one or more PLMNs broadcasting international MCCs and one or more PLMNs broadcasting a respective MCC consistent with a current location of the UE.

In some implementations, in performing the PLMN selection, process 300 may involve processor 212 performing certain operations. For instance, process 300 may involve processor 212 receiving a first broadcast from a first PLMN indicating a first MCC that is associated with a home country of the UE. Additionally, process 300 may involve processor 212 assigning the first PLMN a first priority. Also, process 300 may involve processor 212 receiving a second broadcast from a second PLMN indicating a second MCC that is an international MCC. Moreover, process 300 may involve processor 212 assigning the second PLMN a second priority lower than the first priority. Furthermore, process 300 may involve processor 212 selecting the first PLMN responsive to the first priority being higher than the second priority.

In some implementations, in performing the PLMN selection, process 300 may involve processor 212 performing certain operations. For instance, process 300 may involve processor 212 receiving a first broadcast from a first PLMN indicating a first MCC that is an international MCC. Additionally, process 300 may involve processor 212 assigning the first PLMN a first priority. Moreover, process 300 may involve processor 212 receiving a second broadcast from a second PLMN indicating a second MCC associated with a foreign country different from a home country of the UE. Furthermore, process 300 may involve processor 212 assigning the second PLMN a second priority lower than the first priority. Also, process 300 may involve processor 212 selecting the first PLMN responsive to the first priority being higher than the second priority.

In some implementations, in performing the PLMN selection, process 300 may involve processor 212 performing certain operations. For instance, process 300 may involve processor 212 receiving a first broadcast from a first PLMN indicating a first MCC that is associated with a home country of the UE. Additionally, process 300 may involve processor 212 assigning the first PLMN a first priority. Also, process 300 may involve processor 212 receiving a second broadcast from a second PLMN indicating a second MCC that is an international MCC. Moreover, process 300 may involve processor 212 assigning the second PLMN a second priority lower than the first priority. Additionally, process 300 may involve processor 212 receiving a third broadcast from a third PLMN indicating a third MCC associated with a foreign country different from the home country of the UE. Furthermore, process 300 may involve processor 212 assigning the third PLMN a third priority lower than the second priority. Then, process 300 may involve processor 212 selecting the first PLMN responsive to the first priority being higher than the second priority and the third priority.

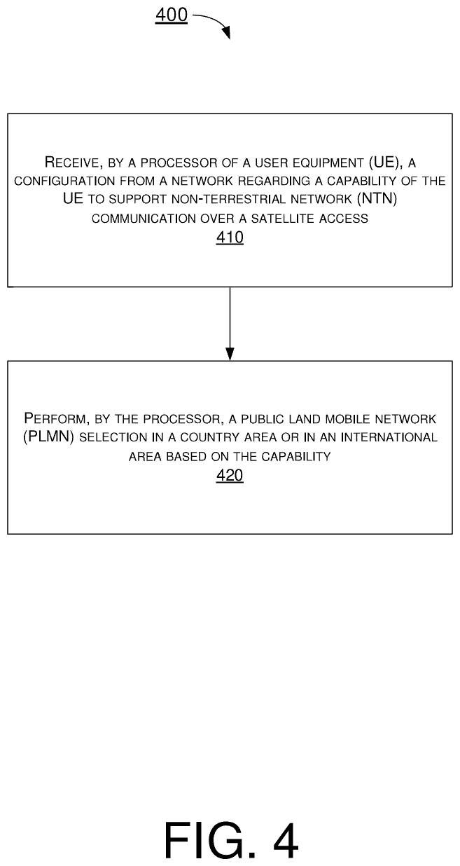

FIG. 4 illustrates an example process 400 in accordance with an implementation of the present disclosure. Process 400 may represent an aspect of implementing various proposed designs, concepts, schemes, systems and methods described above, whether partially or entirely, including those pertaining to those described above. More specifically, process 400 may represent an aspect of the proposed concepts and schemes pertaining to PLMN selection in international areas when a UE supports NTN communications. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively in a different order. Furthermore, one or more of the blocks/sub-blocks of process 400 may be executed iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., terrestrial network node 128 or NT network node 125) of a mobile communication network. Process 400 may begin at block 410.

At 410, process 400 may involve processor 212 of apparatus 210 receiving, via transceiver 216, a configuration from a network (e.g., via apparatus 220) regarding a capability of the UE to support NTN communication over a satellite access. Process 400 may proceed from 410 to 420.

At 420, process 400 may involve processor 212 performing, via transceiver 216, a PLMN selection in a country area or in an international area based on the capability.

In some implementations, in receiving the configuration, process 400 may involve processor 212 receiving the configuration in a RRC or NAS message.

In some implementations, process 400 may involve processor 212 performing additional operations. For instance, process 400 may involve processor 212 receiving, via transceiver 216, from the network during a registration procedure an indication regarding whether or not the UE is allowed to utilize one or more NTNs over the satellite access.

In some implementations, in performing the PLMN selection, process 400 may involve processor 212 performing certain operations. For instance, responsive to the indication indicating the UE is allowed to utilize the one or more NTNs over the satellite access, process 400 may involve processor 212 selecting a PLMN from one or more PLMNs broadcasting international MCCs and one or more PLMNs broadcasting a respective MCC that represents a current location of the UE. Moreover, responsive to the indication indicating the UE is not allowed to utilize the one or more NTNs, process 400 may involve processor 212 selecting another PLMN from one or more PLMNs available over a terrestrial network access.

In some implementations, in performing the PLMN selection, process 400 may involve processor 212 selecting a PLMN one or more PLMNs broadcasting international MCCs and one or more PLMNs broadcasting a respective MCC consistent with a current location of the UE.

In some implementations, in performing the PLMN selection, process 400 may involve processor 212 performing certain operations. For instance, process 400 may involve processor 212 receiving a first broadcast from a first PLMN indicating a first MCC that is associated with a home country of the UE. Additionally, process 400 may involve processor 212 assigning the first PLMN a first priority. Moreover, process 400 may involve processor 212 receiving a second broadcast from a second PLMN indicating a second MCC that is an international MCC. Furthermore, process 400 may involve processor 212 assigning the second PLMN a second priority lower than the first priority. Also, process 400 may involve processor 212 selecting the first PLMN responsive to the first priority being higher than the second priority.

In some implementations, in performing the PLMN selection, process 400 may involve processor 212 performing certain operations. For instance, process 400 may involve processor 212 receiving a first broadcast from a first PLMN indicating a first MCC that is an international MCC. Additionally, process 400 may involve processor 212 assigning the first PLMN a first priority. Also, process 400 may involve processor 212 receiving a second broadcast from a second PLMN indicating a second MCC associated with a foreign country different from a home country of the UE. Moreover, process 400 may involve processor 212 assigning the second PLMN a second priority lower than the first priority. Furthermore, process 400 may involve processor 212 selecting the first PLMN responsive to the first priority being higher than the second priority.

In some implementations, in performing the PLMN selection, process 400 may involve processor 212 performing certain operations. For instance, process 400 may involve processor 212 receiving a first broadcast from a first PLMN indicating a first MCC that is associated with a home country of the UE. Additionally, process 400 may involve processor 212 assigning the first PLMN a first priority. Also, process 400 may involve processor 212 receiving a second broadcast from a second PLMN indicating a second MCC that is an international MCC. Moreover, process 400 may involve processor 212 assigning the second PLMN a second priority lower than the first priority. Additionally, process 400 may involve processor 212 receiving a third broadcast from a third PLMN indicating a third MCC associated with a foreign country different from the home country of the UE. Moreover, process 400 may involve processor 212 assigning the third PLMN a third priority lower than the second priority. Furthermore, process 400 may involve processor 212 selecting the first PLMN responsive to the first priority being higher than the second priority and the third priority.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B”.

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
transmitting, by a processor of a user equipment (UE), a message indicating that the UE has a capability of non-terrestrial network (NTN) communication over a satellite access;
receiving, by the processor, an indication indicating whether the UE is allowed to utilize one or more NTNs over the satellite access; and
performing, by the processor, a public land mobile network (PLMN) selection in a country area or in an international area based on the capability.

2. The method of claim 1, wherein the capability is set as a configuration stored in a memory or a Universal Subscriber Identity Module (USIM).

3. The method of claim 1, wherein the indication is received in a radio resource control (RRC) or non-access stratum (NAS) message.

4. The method of claim 1, wherein the capability message is transmitted or the indication is received during a registration procedure.

5. The method of claim 1, wherein the performing of the PLMN selection comprises:
responsive to the indication indicating the UE is allowed to utilize the one or more NTNs over the satellite access, selecting a PLMN from one or more PLMNs broadcasting international mobile country codes (MCCs) and one or more PLMNs broadcasting a respective MCC that represents a current location of the UE; and
responsive to the indication indicating the UE is not allowed to utilize the one or more NTNs, selecting another PLMN from one or more PLMNs available over a terrestrial network (TN) access.

6. The method of claim 1, wherein the performing of the PLMN selection comprises selecting a PLMN from one or more PLMNs broadcasting international mobile country codes (MCCs) and one or more PLMNs broadcasting a respective MCC consistent with a current location of the UE.

7. The method of claim 1, wherein the performing of the PLMN selection comprises:
receiving a first broadcast from a first PLMN indicating a first mobile country code (MCC) that is associated with a home country of the UE;
assigning the first PLMN a first priority;
receiving a second broadcast from a second PLMN indicating a second MCC that is an international MCC;
assigning the second PLMN a second priority lower than the first priority; and
selecting the first PLMN responsive to the first priority being higher than the second priority.

8. The method of claim 1, wherein the performing of the PLMN selection comprises:
receiving a first broadcast from a first PLMN indicating a first mobile country code (MCC) that is an international MCC;
assigning the first PLMN a first priority;
receiving a second broadcast from a second PLMN indicating a second MCC associated with a foreign country different from a home country of the UE;
assigning the second PLMN a second priority lower than the first priority; and
selecting the first PLMN responsive to the first priority being higher than the second priority.

9. The method of claim 1, wherein the performing of the PLMN selection comprises:
receiving a first broadcast from a first PLMN indicating a first mobile country code (MCC) that is associated with a home country of the UE;
assigning the first PLMN a first priority;
receiving a second broadcast from a second PLMN indicating a second MCC that is an international MCC;
assigning the second PLMN a second priority lower than the first priority;
receiving a third broadcast from a third PLMN indicating a third MCC associated with a foreign country different from the home country of the UE;
assigning the third PLMN a third priority lower than the second priority; and
selecting the first PLMN responsive to the first priority being higher than the second priority and the third priority.

10. A method, comprising:
receiving, by a processor of a user equipment (UE), a configuration from a network regarding a capability of the UE to support non-terrestrial network (NTN) communication over a satellite access; and
performing, by the processor, a public land mobile network (PLMN) selection in a country area or in an international area based on the capability.

11. The method of claim 10, wherein the receiving of the configuration comprises receiving the configuration in a radio resource control (RRC) or non-access stratum (NAS) message.

12. The method of claim 10, further comprising:
receiving, by the processor, from the network during a registration procedure an indication regarding whether or not the UE is allowed to utilize one or more NTNs over the satellite access.

13. The method of claim 12, wherein the performing of the PLMN selection comprises:
responsive to the indication indicating the UE is allowed to utilize the one or more NTNs over the satellite access, selecting a PLMN from one or more PLMNs broadcasting international mobile country codes (MCCs) and one or more PLMNs broadcasting a respective MCC that represents a current location of the UE; and
responsive to the indication indicating the UE is not allowed to utilize the one or more NTNs, selecting another PLMN from one or more PLMNs available over a terrestrial network (TN) access.

14. The method of claim 10, wherein the performing of the PLMN selection comprises selecting a PLMN from one or more PLMNs broadcasting international mobile country codes (MCCs) and one or more PLMNs broadcasting a respective MCC consistent with a current location of the UE.

15. The method of claim 10, wherein the performing of the PLMN selection comprises:
receiving a first broadcast from a first PLMN indicating a first mobile country code (MCC) that is associated with a home country of the UE;
assigning the first PLMN a first priority;
receiving a second broadcast from a second PLMN indicating a second MCC that is an international MCC;
assigning the second PLMN a second priority lower than the first priority; and
selecting the first PLMN responsive to the first priority being higher than the second priority.

16. The method of claim 10, wherein the performing of the PLMN selection comprises:
receiving a first broadcast from a first PLMN indicating a first mobile country code (MCC) that is an international MCC;
assigning the first PLMN a first priority;
receiving a second broadcast from a second PLMN indicating a second MCC associated with a foreign country different from a home country of the UE;
assigning the second PLMN a second priority lower than the first priority; and
selecting the first PLMN responsive to the first priority being higher than the second priority.

17. The method of claim 10, wherein the performing of the PLMN selection comprises:
receiving a first broadcast from a first PLMN indicating a first mobile country code (MCC) that is associated with a home country of the UE;
assigning the first PLMN a first priority;
receiving a second broadcast from a second PLMN indicating a second MCC that is an international MCC;
assigning the second PLMN a second priority lower than the first priority;
receiving a third broadcast from a third PLMN indicating a third MCC associated with a foreign country different from the home country of the UE;
assigning the third PLMN a third priority lower than the second priority; and
selecting the first PLMN responsive to the first priority being higher than the second priority and the third priority.

18. An apparatus implementable in a user equipment (UE), comprising:
a transceiver configured to wirelessly communicate with a network; and
a processor coupled to the transceiver and configured to perform operations comprising:
transmitting, via the transceiver, a message indicating that the UE has a capability of non-terrestrial network (NTN) communication over a satellite access;
receiving, via the transceiver, an indication indicating whether the UE is allowed to utilize one or more NTNs over the satellite access; and
performing, via the transceiver, a public land mobile network (PLMN) selection in a country area or in an international area based on the capability,
wherein the capability is set as a configuration stored in a memory or a Universal Subscriber Identity Module (USIM), and
wherein the indication is received in a radio resource control (RRC) or non-access stratum (NAS) message.

19. The apparatus of claim 18, wherein, in performing the PLMN selection, the processor is configured to perform operations comprising:
receiving a first broadcast from a first PLMN indicating a first mobile country code (MCC) that is associated with a home country of the UE;
assigning the first PLMN a first priority;
receiving a second broadcast from a second PLMN indicating a second MCC that is an international MCC;
assigning the second PLMN a second priority lower than the first priority;
receiving a third broadcast from a third PLMN indicating a third MCC associated with a foreign country different from the home country of the UE;
assigning the third PLMN a third priority lower than the second priority; and
selecting the first PLMN responsive to the first priority being higher than the second priority and the third priority.

20. The apparatus of claim 19, wherein, the first priority, the second priority and the third priority are assigned based on the configuration or another configuration stored in the memory or the USIM.
